(19) United States
(12) Patent Application Publication
(10) Pub. No.: US 2026/0300740 A1
(43) Pub. Date: Oct. 1, 2026

(54) METHOD, DEVICE AND SYSTEM FOR PREDICTING TRAFFIC PARAMETERS OF A ROAD NETWORK

(71) Applicant: GRABTAXI HOLDINGS PTE. LTD., Singapore (SG)

(72) Inventors: Suriyanarayanan VENKATESAN, Singapore (SG); Padarn George WILSON, Singapore (SG); Chen LIANG, Singapore (SG)

(21) Appl. No.: 19/100,952

(22) PCT Filed: Jul. 28, 2023
(86) PCT No.: PCT/SG2023/050529

§ 371 Date: Feb. 4, 2025

(30) Foreign Application Priority Data
Aug. 5, 2022 (SG) 10202250678H

(51) Int. Cl. G06N 3/0895; G06N 3/042; G06N 3/0464

(52) U.S. Cl. CPC G06N 3/0895; G06N 3/042; G06N 3/0464

(57) ABSTRACT

Aspects concern a computer-implemented method for predicting traffic parameters on a road network comprising the steps of: loading a spatial data file associated with the road network and a corresponding network profile associated with the road network; converting the spatial data file to an edge-based graph comprising a plurality of nodes and edges, each node representing a respective road segment of the road network and each edge representing a respective physical location; extracting a plurality of road attributes associated with the road network and deriving corresponding node features based on the plurality of road attributes; inputting the edge-based graph, node features and network profile into a machine learning algorithm for predicting network parameters on each respective road segment; wherein the machine learning algorithm is configured to output a set of traffic parameters corresponding to each of the plurality of nodes.

### TECHNICAL FIELD

Various aspects of this disclosure relate to methods, devices and systems for predicting one or more traffic parameters on a road network.

### BACKGROUND

Obtaining traffic data on a road network is useful as part of the process for building robust travel patterns. However, due to limitations associated with deployment of sensors or uneven distribution of traffic data obtained, the obtained path-based data typically suffer from incompleteness and relatively low network-coverage, that is, traffic data of one or more road segments may be missing. Approximation and inference methods and systems are typically performed on network segments that are detected to suffer from missing traffic data.

A known method of predicting or inferring traffic on a road segment is the use of historical traffic patterns, such as historic mean or median speeds on the road segment, and the road-class level speed profiles to overcome data sparsity issues. There are also existing statistics-based algorithms that run, for example, regression techniques to predict missing traffic data. However, current methods fail to account for or exploit underlying road network structure and properties.

There exists a need for an improved method, system and device for predicting or inferring traffic data on a road network.

### SUMMARY

The disclosure provides a method, device and/or system predicting traffic parameters of a road network. In some embodiments, a machine learning algorithm, such as Graph Convolution network, is used to facilitate prediction. In some embodiments, underlying road network structure and properties may be incorporated via the modelling of transition penalization for the task of network smoothing to further improve prediction or inference of missing segment level speeds on a road network.

According to an aspect of the disclosure there is a computer-implemented method for predicting traffic parameters on a road network comprising the steps of: loading a spatial data file associated with the road network and a corresponding network profile associated with the road network; converting the spatial data file to an edge-based graph comprising a plurality of nodes and edges, each node representing a respective road segment of the road network and each edge representing a respective physical location; extracting a plurality of road attributes associated with the road network and deriving corresponding node features based on the plurality of road attributes; inputting the edge-based graph, node features and network profile into a machine learning algorithm for predicting network parameters on each respective road segment; wherein the machine learning algorithm is configured to output a set of traffic parameters corresponding to each of the plurality of nodes.

The plurality of road attributes may include at least two of the following: a road length, a road width, a number of lanes, a direction and a road type.

In some embodiments, the method further comprises a step of receiving the plurality of road attributes and the edge-based graph as input, and constructing a set of transitioning rules for assigning traffic parameters to one or more adjacent road segments associated with each of the plurality of road segments.

In some embodiments, if the one or more adjacent road segments are of the same road type as the road segment, the set of transitioning rules includes a rule stating that a similar range of traffic parameters is to be assigned to the one or more adjacent road segments.

In some embodiments, the method further comprises a step of pre-processing the extracted plurality of road attributes, wherein the pre-processing includes at least one of the following: binning and one-hot encoding the road-length of each road segment into the plurality of distance brackets, normalization, clustering, and assigning binary values for categorization.

In some embodiments, the method further comprises a step of computing a matrix representation of the edge-based graph, wherein the matrix comprises a normalized Adjacency and Laplacian matrix.

In some embodiments, the machine learning algorithm comprises a graph convolutional network (GCN).

In some embodiments, the method further comprises a step of checking the set of output traffic parameters for one or more entries that fall out of range.

In some embodiments, the method further comprises a step of training the GCN, wherein the GCN is modelled as a two-layer GCN and a fully-connected layer for learning the traffic parameter propagation based on a subset of traffic prior information as a semi-supervised learning task.

In some embodiments, the training comprises defining an objective function to minimize a root-mean-squared error measure associated with incorrect assignment of traffic parameters to one or more road segments.

According to another aspect of the disclosure there is a device for predicting traffic parameters on a road network comprising a processor configured to: receive a spatial data file associated with the road network and a corresponding network profile associated with the road network; convert the spatial data file to an edge-based graph comprising a plurality of nodes and edges, each node representing a respective road segment of the road network and each edge representing a respective physical location; extract a plurality of road attributes associated with the road network and deriving corresponding node features based on the plurality of road attributes; input the edge-based graph, node features and network profile into a machine learning algorithm for predicting network parameters on each respective road segment;
wherein the machine learning algorithm is configured to output a set of traffic parameters corresponding to each of the plurality of nodes.

According to another aspect of the disclosure there is a system for predicting traffic parameters on a road network comprising the aforementioned device arranged in data communication with a map service to receive spatial data file from the map service.

According to another aspect of the disclosure there is a non-transitory computer-readable storage medium comprising instructions, which, when executed by one or more processors, cause the execution of the aforementioned method.

In an embodiment, the method further comprises a step of receiving the plurality of road attributes and the edge-based graph as input, and constructing a set of transitioning rules for assigning traffic parameters to one or more adjacent road segments associated with each of the plurality of road segments. The set of transitioning rules advantageously account for underlying road attributes/structure and provides for a smoothing (curve-fitting/low pass filtering) to more efficiently predict traffic parameters on each road segment.

### BRIEF DESCRIPTION OF THE DRAWINGS

The disclosure will be better understood with reference to the detailed description when considered in conjunction with the non-limiting examples and the accompanying drawings, in which:

FIG. 1 is a flow diagram of a method for predicting traffic parameters of a road network according to an embodiment;

FIG. 2 is a flow diagram of the method of FIG. 1, with further sub-steps for predicting traffic parameters of a road network according to another embodiment;

FIG. 3 is a block diagram depicting a model architecture for training a GCN according to an embodiment;

FIG. 4A to FIG. 4C show various results associated with applying the method for predicting traffic parameters of a road network according to various embodiments; and

FIG. 5 shows a schematic illustration of a processor for predicting traffic parameters of a road network in accordance with an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure systems, devices or methods are analogously valid for the other systems, devices or methods. Similarly, embodiments described in the context of a system are analogously valid for a device or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “data” may be understood to include information in any suitable analog or digital form, for example, provided as a file, a portion of a file, a set of files, a signal or stream, a portion of a signal or stream, a set of signals or streams, and the like. The term data, however, is not limited to the aforementioned examples and may take various forms and represent any information as understood in the art.

As used herein, the term “spatial data” refers broadly to data in various formats that is associated with a geographical location or area. Non-limiting examples of spatial data include satellite imagery, georeferenced maps in two-dimensional, three-dimensional form. Such spatial data may be stored in various file formats with or without metadata. A non-limiting example of a spatial data file is a map having geographical locations encoded based on the Geohash format.

As used herein, the term “module” refers to, or forms part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. A single module or a combination of modules may be regarded as a device.

As used herein, the term “graph” refers to a mathematical structure for modelling relationships between two or more objects. A graph comprises vertices (nodes) connected by edges.

As used herein, the term “road network” refers broadly to any physical roads suitable for vehicles to travel thereon, the road network comprises a plurality of road segments meeting at a transition point. Non-limiting examples of such transition point may include a junction, a filter, a slip road etc.

As used herein, the term “traffic parameters” may broadly refer to a mean/median speed on a road segment and/or road network, and may also include other distance and time derivable parameters.

As used herein, the term “associate”, “associated”, and “associating” indicate a defined relationship (or cross-reference) between two items. For instance, spatial data file and/or a plurality of attributes may be associated with a geographical feature such as a road network or part thereof.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

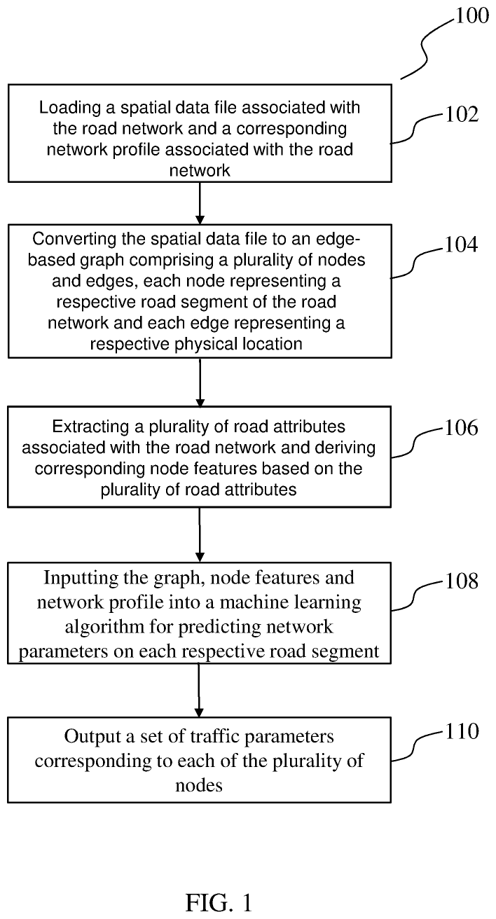

According to an aspect of the disclosure and referring to FIG. 1, there is a method 100 for predicting traffic parameters of or associated with a road network. The method may be implemented using a computer or processor, and comprises the steps of: loading a spatial data file associated with the road network and a corresponding network profile associated with the road network (step 102); converting the spatial data file to an edge-based graph comprising a plurality of nodes and edges, each node representing a respective road segment of the road network and each edge representing a respective physical location (step 104); extracting a plurality of road attributes associated with the road network and deriving corresponding node features based on the plurality of road attributes (step 106); inputting the graph, node features and network profile into a machine learning algorithm for predicting network parameters on each respective road segment (step 108); wherein the machine learning algorithm is configured to output a set of traffic parameters corresponding to each of the plurality of nodes (step 110).

The method 100 is suited for predicting traffic speed or speed profile on the road network. In an embodiment, the road network may comprise a plurality of road segments, each road segment having a specific speed profile. The predicted output of method 100 may be used to assign missing speed profiles to corresponding road segments due to incomplete on-site information gathering, and/or may be used to revise or update outdated speed profiles.

In step 102, the spatial data file may be a geographical map of an area comprising the road network. The geographical map may be a Geohash level 5 map which spans a 4.9 kilometers (km) by 4.9 km grid. The map data may be modelled as a Graph G′, where each node represents a location tuple (comprising a latitude and a longitude), and each edge between the location represent a road segment. The network profile may be a historical profile of previously obtained speed profiles or real-time speed profiles. The network profile may be subsequently utilized for training the machine learning algorithm.

In step 104, the Graph G′ with |V| nodes and |E| edges is converted to an edge-based graph representation G. This representation is obtained by converting each edge in G′ into a node in G and every node in G′ into an edge (link) in G. After the conversion, every node in G will represent a physical road segment, and adjacent nodes in G will learn the propagation of speed across nodes. Examples of physical location include non-road features such as buildings, structures, and/or landmarks. Each physical location may be connected to another physical location via a road segment.

In step 106, each node feature may correspond to features or road attributes of underlying road segment such as, but not limited to, a road length, a road width, number of lane(s), directions (for example, one-way traffic or two-way traffic), road type/class (primary, secondary, tertiary, etc.). Such information may be obtained from publicly available geospatial data sources or from dedicated databases. In some embodiments, the road class feature may include thirteen types/classes, as follows: trunk, secondary, service, residential, primary, motorway link, primary link, tertiary, motorway, living street, secondary link, tertiary link, trunk link. Any road class feature not recognized as any of the above thirteen types may be deemed “unclassified”.

In step 108, the machine learning algorithm may be a graph convolutional network (GCN) or any other type of graph-based machine learning model or algorithm.

In step 110, the output set of traffic parameters may be used to infer missing traffic parameters such as traffic speed profile of each road segment.

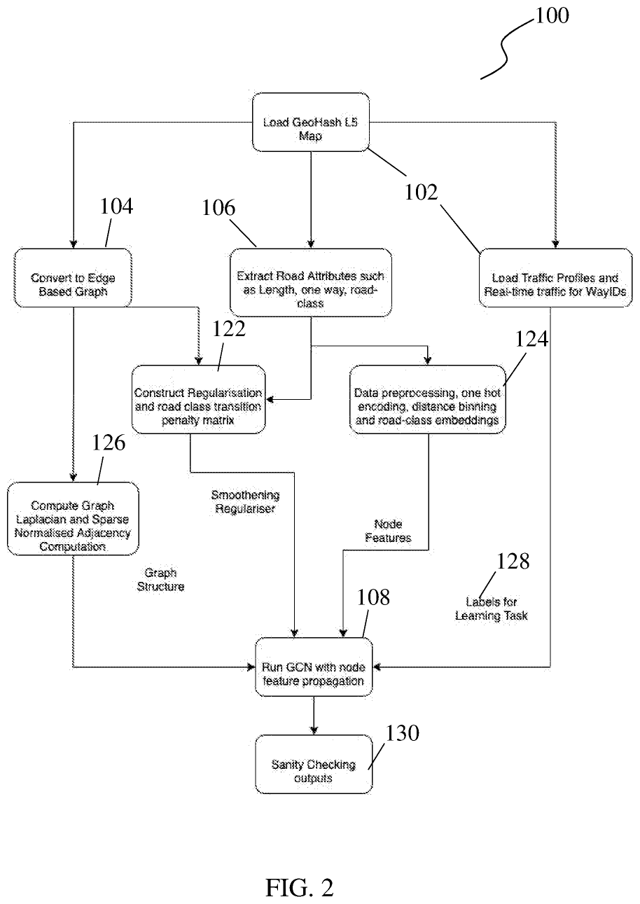

FIG. 2 shows another embodiment of a method 100 for completing traffic network using GCN. It is appreciable that the FIG. 2 may be regarded a specific embodiment of the steps in FIG. 1, for the prediction of speed profile of a road network using Graph Convolution Network.

Step 122 comprises receiving the plurality of road attributes and the edge-based graph as input, and constructing a set of transitioning rules for assigning traffic parameters to one or more adjacent road segments associated with each of the plurality of road segments.

In some embodiments, the transitioning rules is motivated by an implicit relation for transitioning between road segments, which assumes that traffic from one road segment to an adjacent road segment have an “inherent smoothness” in road traffic patterns. For example, two road segments adjacent to and connected to each other, belonging to the same class or type (e.g. primary), will tend to have similar traffic distributions and travel trends. The “inherent smoothness” principle may be explicitly expressed in the form of a transition rule, such as “connected roads should have similar traffic”. In some embodiments, the transition rule may form part of a regularization and transition penalty matrix to train the machine learning algorithm and so as to avoid over-fitting. The transition rule may be applicable to all adjacent road segments belonging to the same road class as the road segment.

One exception to the aforementioned rule is that transitions across different road classes—i.e. a primary road leading to a secondary or tertiary road can (and must) have different traffic speeds, whereas connected primary roads should exhibit inherent smoothness. Any assignment of traffic speeds on an adjacent road segment which does not obey the above rules, and therefore result in a speed jump, may be modelled as a penalty function of the machine learning model so as to minimize segment level differences in speed jumps to enforce or promote learning of the model towards achieving smoothness. In some embodiments, the penalty may be modelled as penalty coefficient in the machine learning algorithm in the form of a GCN. The penalty coefficient may be derived from the speed profiles across different road classes.

In general, if the one or more adjacent road segments are of the same road type or class as the road segment, the set of transitioning rules includes a rule stating that a similar range of traffic parameters (traffic speed) is to be assigned to the one or more adjacent road segments.

Step 124 comprises pre-processing the extracted plurality of road attributes of step 106, wherein the pre-processing includes at least one of the following: binning and one-hot encoding the road-length of each road segment into the plurality of distance brackets, normalization, clustering, and assigning binary or integer values for categorization. The pre-processing step may be used for or form part of feature construction for subsequent machine learning.

In some embodiments, the binning and one-hot encoding of the road-length into a plurality of distance buckets may be adaptive distance buckets defined as for example [0 m,10 m], [10 m,50 m], [50 m,100 m], [100 m,200 m], [200 m,500 m], [500 m,1000 m], [1000 m—Above].

In some embodiments, the normalization of road segments may include defining each road segment such that each road segment has exactly one incoming and outgoing road. In the binning step, adaptive bin estimates may create a representative distribution approximation of underlying road lengths. The road class feature was one-hot encoded into one of the predefined thirteen types/classes.

In some embodiments, binary categorization may include representing some of the extracted road attributes as binary values. For example, a one-way road segment may be expressed as a binary categorical value (1—Yes, 0—No). In-degree and out-degree values may be treated as integers.

In some embodiments, a trainable embedding encoder may be used for implicit featurization.

Step 126 comprises the construction of a matrix representation of the edge-based graph, wherein the matrix comprises a normalized Adjacency and Laplacian matrix.

The construction of a normalized graph Laplacian and (sparse) Adjacency Matrix may be as follows.

### Adjacency Matrix

Consider a graph G (V, E), where V represents its vertices (nodes) and, E, its corresponding edges. An adjacency matrix A is constructed as follows
A(i,j)=1 if there exists an edge eᵢⱼ connecting node vᵢ to vⱼ, 0 otherwise
where i and j correspond to the vᵢ and vⱼ nodes in V

### Normalized Adjacency Matrix

$$A = {D}^{- 1 / 2} {AD}^{- 1 / 2}$$

For a graph G, its Graph Laplacian L is defined as follows

$$L = D - A ,$$

where D is its diagonal node degree matrix (each diagonal element is its sum of incoming/outgoing edges), and A, its adjacency. An adjacency matrix captures relationships between nodes of the Graph.

In step 128, labels are generated based on the traffic profiles and/or real-time traffic in step 102. The machine learning may be modelled as a semi-supervised label propagation, where partial labels (priors) may be propagated via the GCN. The target values which need to be propagated, may be traffic speed values, which may be loaded to a memory unit of a computer or processor executing the method 100. In some embodiments, the traffic speeds can either be real-time speeds aggregated over a pre-defined window, such as a 15-minute rolling window at each road segment level, or historic traffic profiles aggregated at adaptive buckets of 30 mins-60 mins at a way-id level (i.e. one way or two way) by mean or median aggregation, depending on the context of application such as real-time traffic inference, historical traffic inference, etc.

In step 130, the checking of outputs (i.e. sanity checks or checking) may comprise a step of checking the set of output traffic parameters for one or more entries that fall out of range. Such checks may be important to ensure the quality of the traffic speed propagation, implementation of the transitioning rules, and correct any spurious entries that might be generated via the machine learning model. Examples of such spurious entries include negative or zero speed values, more than a speed limit, for example speed greater than 30 metres/second (m/s) on a road segment.

In some embodiments, the checking of outputs may include road class level bound for each city/geo-hash can be computed via aggregation of historic data for each time of day, weekday/weekend.

In some embodiments, for spurious entries associated with road segments having negative speeds, the spurious entry(ies) may be corrected to default speed profiles. The default speed profiles may be based on road-segment, road-class, historic speeds or global default.

In some embodiments, the sanity checks may include road class level checks in the following two-step checks:

First step check: check if speeds are within the lower and upper bound of speeds, for example—
i. Motorway road speed range—[10 m/s to 30 m/s]
ii. Service road speed range—[2 m/s-10 m/s] (and so on)

Second step check: check if speeds are within a statistical measure, [road-class mean−3 standard deviation, road-class mean±standard deviation] range
iii. Ensure 6-sigma correctness of speeds within >90% confidence interval of the mean (this is done to ensure the smoothening aligns with historic patterns)

The sanity checks may also include further statistical measures including mode.

In step 108, the step of executing or running the GCN (Graph convolution networks) for traffic speed value propagation so as to complete any missing values on the road network may be based on performs weighted aggregation of the node features and propagates the latent information through its adjacency structure based on the Laplacian matrix generated in step 126. As the converted edge-based graph node represents a road segment, road attributes such as length, road-class type, number of lanes, one-way information, in-degree, and out-degree of the nodes of the graph (i.e. for each road segment, how many adjacent road segments are connected), may be regarded as associated node features.

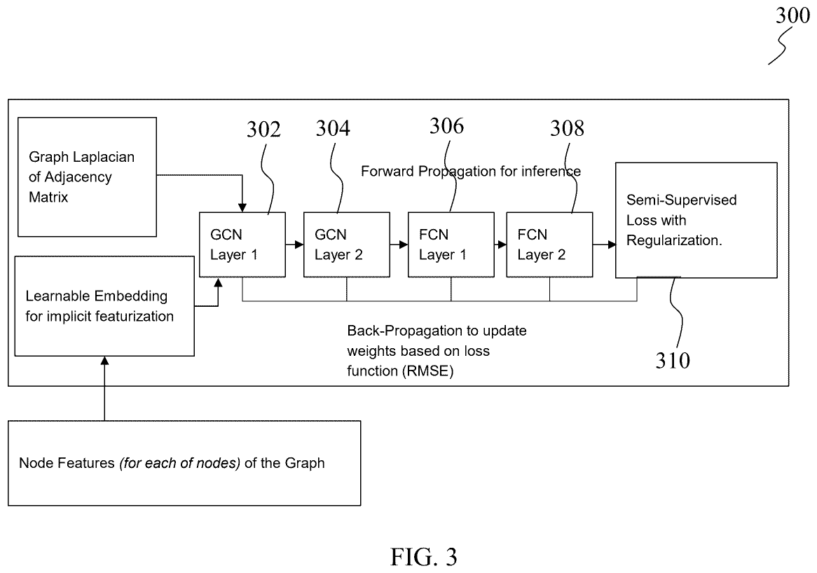

FIG. 3 shows a model architecture 300 of a GCN, including an overview of model training. The graph network and its corresponding node features obtained from steps 122, 124, 126, 128 may be passed into a two-layer GCN (GCN layer 302 and GCN layer 304) followed by fully-connected layers 306, 308 for learning the traffic speed propagation based on a subset of traffic prior information as a semi-supervised learning task. Each of the layers 302, 304, 306, 308 may be implemented as separate modules, or may be integrated as one single module or processor. The error minimization module 310 computes the semi-supervised loss as a linear combination of the following components:
Root mean square error (RMSE): For the model training, a set of data comprising actual speed values may form a training dataset. In some embodiments, 80% of the road network with actual speed values may be used for training and learning latent speeds via optimizing to minimize a Root-Mean-Squared Error Loss (RMSE).
Smoothness Penalty: In the process of smoothening using the transitioning rules, adjacent road segments are to have similar speeds (say 1 Motorway, linked/mapped to 2 different segments, need to have similar speeds). A smoothening regularizer module may be used to enforce smoothness in predictions. As one exception to the smoothness penalty, transition between road-class such as motorway to primary, etc. may be considered. In these cases where the road class are different, a transition factor may be introduced to account for the change in road class to allow “discontinuity/jumps” in speeds.

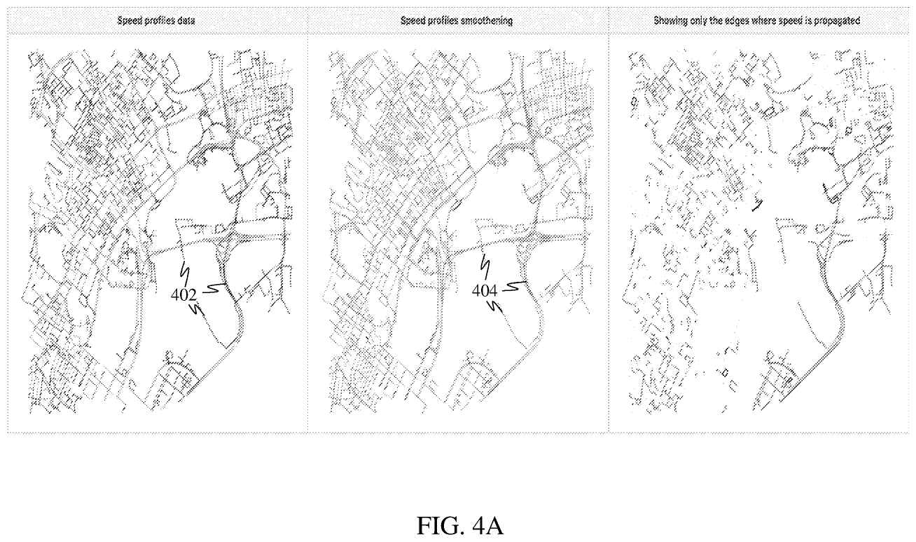

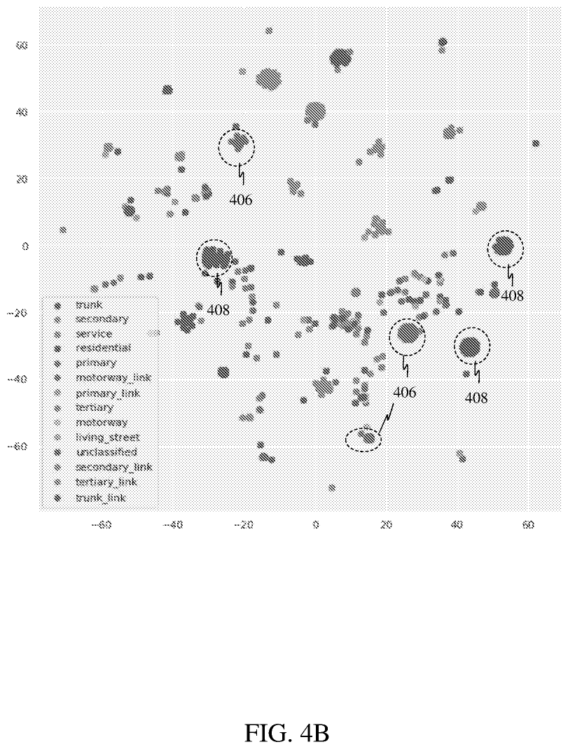

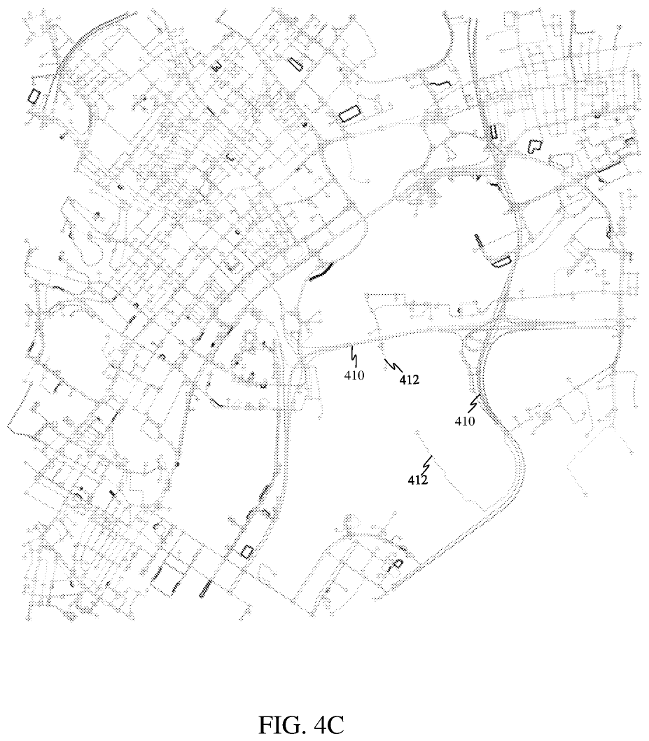

FIG. 4A shows an example of traffic around a road network comprising a plurality of road segments, at a particular time, e.g. post-midnight. The darkened (black) roads in the left most image labelled or marked 402 shows missing traffic/vehicle information. The centre image show the speed profile smoothening for the entire road network obtained by the method 100, with portions marked 404 representing propagated values. The right most image shows only the edges where speed is propagated.

FIG. 4B is a t-Distributed Stochastic Neighbour Embedding (t-SNE) visualization of learned node embeddings post model training. A relatively clear clustering of nodes based on their road class proximity and features may be seen. As examples, relatively clear clusters based on the primary road class is labelled 406, and clusters based on residential road class is labelled 408.

FIG. 4C is a visualization of predicted traffic speeds, checkpointed over every ten iterations of the trained model. Network learning to propagate speed over iterations are marked as 410 (earlier iterations) and 412 (later iterations), demonstrating the efficacy of the algorithm to predict and assign traffic speeds to various road segments. The visualization shows that speed profiles have been assigned to most road segments with the exception of a few areas with black portions.

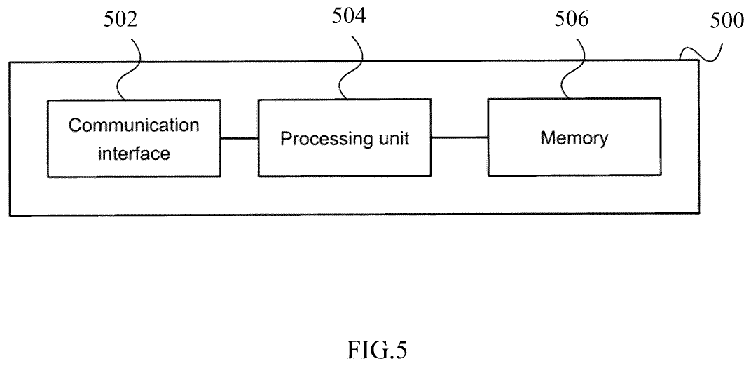

FIG. 5 shows a server computer 500 according to various embodiments. The server computer 500 includes a communication interface 502 (e.g. configured to receive input spatial data from the one or more map source). The server computer 500 further includes a processing unit 504 and a memory 506. The memory 506 may be used by the processing unit 504 to store, for example, data to be processed, such as data associated with the input spatial data and intermediate results or final output from one or more of steps 102, 104, 106, 108, 122, 124, 126, 128, 130. The server computer 500 is configured to perform the method of FIG. 1 and/or FIG. 2, and/or FIG. 3. It should be noted that the server computer system 500 can be a distributed system including a plurality of computers. The memory 506 may include a non-transitory computer readable medium.

In various embodiments, where machine learning (ML) models are used, the ML model may be trained by supervised method, semi-supervised method, unsupervised method and/or a combination of the aforementioned.

It is contemplated that as addition or alternative to the specific ML algorithms as described, other algorithms such as evolutionary algorithms, genetic algorithms, expert rule-based systems may be used.

It is contemplated that the output of the method, system and/or device as described may be deployed as input for subsequent modelling of travel time prediction systems, congestion prediction system, traffic flow modelling, etc. For example, the traffic profile associated in each road segment may be used for travel time estimation for an on-demand vehicle service between a source and a destination.

The described system may be simple to implement as spatial data may be readily available, a subset of traffic data may be obtained and machine learning used to infer traffic for the entire road network. By representing the road network as an edge-based graph, and considering underlying road attributes and properties, a weighted average function may be formulated that combines traffic from neighboring roads to extrapolate inference for all nodes. The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A computer-implemented method for predicting traffic parameters on a road network comprising the steps of:
loading a spatial data file associated with the road network and a corresponding network profile associated with the road network;
converting the spatial data file to an edge-based graph comprising a plurality of nodes and edges, each node representing a respective road segment of the road network and each edge representing a respective physical location;
extracting a plurality of road attributes associated with the road network and deriving corresponding node features based on the plurality of road attributes; and
inputting the edge-based graph, node features and network profile into a machine learning algorithm for predicting network parameters on each respective road segment;
wherein the machine learning algorithm is configured to output a set of traffic parameters corresponding to each of the plurality of nodes.

2. The method of claim 1, wherein the plurality of road attributes includes at least two of the following: a road length, a road width, a number of lanes, a direction and a road type.

3. The method of claim 2, further comprising a step of receiving the plurality of road attributes and the edge-based graph as input, and constructing a set of transitioning rules for assigning traffic parameters to one or more adjacent road segments associated with each of the plurality of road segments.

4. The method of claim 3, wherein if the one or more adjacent road segments are of the same road type as the road segment, the set of transitioning rules includes a rule stating that a similar range of traffic parameters is to be assigned to the one or more adjacent road segments.

5. The method of claim 1, further comprising pre-processing the extracted plurality of road attributes, wherein the pre-processing includes at least one of the following: binning and one-hot encoding the road-length of each road segment into the plurality of distance brackets, normalization, clustering, and assigning binary values for categorization.

6. The method of claim 1, further comprising a step of computing a matrix representation of the edge-based graph, wherein the matrix comprises a normalized Adjacency and Laplacian matrix.

7. The method of claim 1, wherein the machine learning algorithm comprises a graph convolutional network (GCN).

8. The method of claim 1, further comprising a step of checking the set of output traffic parameters for one or more entries that fall out of range.

9. The method of claim 7, further comprising training the GCN, wherein the GCN is modelled as a two-layer GCN and a fully-connected layer for learning the traffic parameter propagation based on a subset of traffic prior information as a semi-supervised learning task.

10. The method of claim 9, wherein the training comprises defining an objective function to minimize a root-mean-squared error measure associated with incorrect assignment of traffic parameters to one or more road segments.

11. A device for predicting traffic parameters on a road network comprising a processor configured to:
receive a spatial data file associated with the road network and a corresponding network profile associated with the road network;
convert the spatial data file to an edge-based graph comprising a plurality of nodes and edges, each node representing a respective road segment of the road network and each edge representing a respective physical location;
extract a plurality of road attributes associated with the road network and deriving corresponding node features based on the plurality of road attributes; and
input the edge-based graph, node features and network profile into a machine learning algorithm for predicting network parameters on each respective road segment;
wherein the machine learning algorithm is configured to output a set of traffic parameters corresponding to each of the plurality of nodes.

12. The device of claim 11 is arranged in data communication with a map service to receive spatial data file from the map service.

13. A non-transitory computer-readable storage medium comprising instructions, which, when executed by one or more processors, cause the one or more processors to execute a method for predicting traffic parameters on a road network comprising:
loading a spatial data file associated with the road network and a corresponding network profile associated with the road network;
converting the spatial data file to an edge-based graph comprising a plurality of nodes and edges, each node representing a respective road segment of the road network and each edge representing a respective physical location;
extracting a plurality of road attributes associated with the road network and deriving corresponding node features based on the plurality of road attributes; and
inputting the edge-based graph, node features and network profile into a machine learning algorithm for predicting network parameters on each respective road segment;
wherein the machine learning algorithm is configured to output a set of traffic parameters corresponding to each of the plurality of nodes.
